(19) United States
(12) Patent Application Publication
(10) Pub. No.: US 2025/0256262 A1
(43) Pub. Date: Aug. 14, 2025

(54) PAN FIBER-BASED GOLD ADSORPTION MATERIAL AND ITS MANUFACTURING METHOD AND GOLD RECOVERY METHOD USING THE SAME

(71) Applicant: KOREA INSTITUTE OF SCIENCE AND TECHNOLOGY, Seoul (KR)

(72) Inventors: Jae Woo CHOI, Seoul (KR); Youngkyun JUNG, Seoul (KR); Kyung-Won JUNG, Seoul (KR); Sujin YOON, Seoul (KR)

(21) Appl. No.: 18/649,910

(22) Filed: Apr. 29, 2024

(30) Foreign Application Priority Data
Feb. 14, 2024 (KR) 10-2024-0021089

(51) Int. Cl. B01J 20/26; B01J 20/28; B01J 20/32; C02F 1/28; C02F 101/20; C02F 103/34

(52) U.S. Cl. CPC B01J 20/262; B01J 20/28028; B01J 20/3212; C02F 1/285; C02F 2101/20; C02F 2103/34

(57) ABSTRACT

The present invention relates to a PAN fiber-based gold absorption material, a method of manufacturing the same, and a method of recovering gold using the same, which may implement an excellent gold absorbent property, excellent durability, excellent manufacturability, and excellent usability through a structure in which an alkylamine compound is immobilized on a polyacrylonitrile (PAN) fiber. The PAN fiber-based gold absorption material according to the present invention is provided to adsorb gold ions in water, which is configured to have a structure in which the alkylamine compound is immobilized on a PAN fiber surface.

### CROSS REFERENCE TO RELATED APPLICATION

The present application claims priority to Korean Patent Application No. 10-2024-0021089, filed on Feb. 14, 2024, the entire contents of which is incorporated herein for all purposes by this reference.

### BACKGROUND OF THE INVENTION

### Field of the Invention

This invention was made with the support of the Ministry of Science and ICT under Project No. 1711191619, which was conducted under the research project entitled “Developing customized module to enhance applicability of reactive filter under extreme environment” within the project named “Nano Material Technology Development” under the management of the National Research Foundation of Korea, from Jan. 1, 2023 to Dec. 31, 2023.

The present invention relates to a PAN fiber-based gold absorption material, a method of manufacturing the same, and a method of recovering gold using the same, and more particularly to a PAN fiber-based gold absorption material, a method of manufacturing the same, and a method of recovering gold using the same, in which excellent gold absorbent property, excellent durability, excellent manufacturability, and excellent usability can be implemented through a structure in which an alkylamine compound is immobilized on a polyacrylonitrile (PAN) fiber.

### Description of the Related Art

Absorption materials are used to recover gold from industrial wastes such as electrical and electronic wastes, and a diameter of the absorption material is being reduced to a few hundred um to a few nm to increase the recovery efficiency by maximizing a specific surface area. As described above, the smaller diameter of the absorption material improves the gold recovery efficiency, but it is difficult to recover the absorption material after use due to a small size, and the high pressure drop during the gold recovery process makes it less economical.

In contrast, when the gold absorption material has a diameter of mm size, no pressure drop occurs during the gold recovery process, but there is a problem that the pores of the absorption material are blocked by suspended solid materials, which reduces the absorption efficiency of the absorption material.

In addition, the absorption selectivity on gold ions (Au ion) needs to be taken into consideration in the gold recovery process using the absorption material. In addition to the gold ions, various metallic ions are present in the gold recovery process, and it is known that up to 14 metallic ions such as copper (Cu), nickel (Ni), cobalt (Co), zinc (Zn), and the like may coexist with the gold ions. These metallic ions block the pores of the gold absorption material and act as a factor that reduces the absorption efficiency of the absorption material, and thus it is necessary for the gold absorption material to selectively adsorb only gold ions in the environment where these metallic ions are present.

Korean Patent No. 2284087 discloses a porous absorption material for absorption of gold ions having a diameter of 1 to 100 μm coated with a polyphenol-based compound on the surface of a porous polymer particle, but due to the small size, difficulties in the recovery of the absorption material are expected, and the condition that a light source of a specific wavelength needs to be irradiated for the absorption of gold ions is essential. In addition, there is a possibility that the pores of the absorption material may be blocked by various suspended solid materials during the gold recovery process.

U.S. Pat. No. 10,301,180 discloses a method of regenerating activated carbon used in a gold recovery process, but does not disclose a configuration for recovering the activated carbon used in the gold recovery process, thus difficulties such as those described above in the recovery of gold absorption material are expected.

Mesoporous Silica Derived from Municipal Solid Waste Incinerator (MSWI) Ash Slag: Synthesis, Characterization and Use as Supports for Au (III) Recovery, Yosep Hand, etc., 2021, Materials, 14, 6894, presents a technique for adsorbing gold ions by manufacturing a silica particle having a porous structure, but no consideration is given to the difficulty in recovering the silica particle and the blockage of the pores of the silica particle by metallic ions that may coexist during the gold recovery process.

In addition, International Patent Publication WO2019-131946 discloses a technique for recovering gold from a solution containing gold cyanodeposits using a cross-linked resin that includes vinylamine units, and U.S. Pat. No. 4,723,998 discloses a technique for recovering gold from carbonate minerals using an ion exchange resin.

Meanwhile, various alkylamines have been proposed as gold absorption materials based on excellent absorption and reduction capabilities (see Non-patent Document 2). However, the alkylamine has the characteristic of being easily soluble in aqueous solution due to the strong hydrophilicity, which causes difficulties in the application as a gold absorption material.

In order to solve the problem of high water solubility of alkylamine, the present applicant and inventors proposed a “gold absorption material with a core-shell structure provided with a three-dimensional radial pore structure” as disclosed in Korean Patent Publication No. 2023-0148067 (Patent Document 5). The gold absorption material disclosed in Patent Document 5 forms a three-dimensional radial pore structure inside the gold absorption material made of polyacrylonitrile (PAN), and an amine functional group is immobilized in the pores to suppress the amine functional group from dissolving in an aqueous solution.

### SUMMARY OF THE INVENTION

The present disclosure has been made in an effort to solve the above-mentioned problems, and an object of the present invention is to provide a PAN fiber-based gold absorption material, which is capable of improving the durability of the gold absorption material through a structure in which an alkylamine compound is immobilized on a polyacrylonitrile (PAN) fiber.

In addition, still another object of the present invention is to provide a technology capable of suppressing a pressure drop phenomenon caused by the gold absorption material in the process of gold recovery while improving the recoverability of the gold absorption material by implementing a PAN fiber-based gold absorption material having a diameter of um size.

Further, still another object of the present invention is to provide a PAN fiber-based gold absorption material that exhibits the highest level of gold absorbent property compared to known gold absorption materials that include nanometer (nm) sized gold absorption materials.

In addition, the present invention is further directed to provide a PAN fiber-based gold absorption material that exhibits high gold recovery efficiency even in an environment where various metallic ions coexist.

There is provided a PAN fiber-based gold absorption material including a structure in which an alkylamine compound is immobilized on a PAN fiber surface to adsorb gold ions in water.

The PAN fiber-based gold absorption material may has a maximum absorption capacity of gold of 600 mg/g or more.

The alkylamine compound may have a molecular weight of 25,000 g/mol or more.

The alkylamine compound may be immobilized by an amination reaction between the alkylamine compound and the PAN fiber, and a molarity of grafted molecules of the alkylamine compound may be less than 1 mmol/g at an occasion when the amination reaction is terminated.

The alkylamine compound may be a branched alkylamine compound.

The branched alkylamine compound may be one of branched poly(ethyleneimine) (bPEI), iso-buthylamine, sec-buthylamine, iso-amylamine, phosphoethanolamine (PEA), trimethylamine, or iso-propylamine, or a combination thereof.

There is provided a method of manufacturing a PAN fiber-based gold absorption material, the method may include: manufacturing a PAN fiber-based gold absorption material by adding a PAN fiber to an aqueous solution of an alkylamine compound and immobilizing the alkylamine compound on a PAN fiber surface through an amination reaction, in which a molality of grafted molecules of the alkylamine compound may be less than 1 mmol/g at an occasion when the amination reaction is terminated.

The manufactured PAN fiber-based gold absorption material may have a maximum absorption capacity of gold of 600 mg/g or more.

There is provided a method of recovering gold using a PAN fiber-based gold absorption material according to the present invention, the method may include: acidifying a solution to be treated that includes gold ions; and adding the PAN fiber-based gold absorption material to the solution to be treated under an acidic condition, in which, upon addition of the gold absorption material to the solution to be treated under the acidic condition, amine functional groups provided in an alkylamine compound are bonded with hydrogen ions (H+) to electrically form a (+) polar state, the gold ions are bonded with negative ions to form a (−) polar state, and other metallic ions present in the solution to be treated maintain a positive ionic state, the gold ions in the (−) polar state are adsorbed to the amine functional groups in the (+) polar state, and the other metallic ions maintaining the positive ionic state are not adsorbed to the amine functional groups in the (+) polar state.

A PAN fiber-based gold absorption material, a method of manufacturing the same, and a method of recovering gold using the same according to the present invention have the following effects.

The maximum absorption capacity of gold ions is 1463 mg/g, which is significantly superior to a gold absorption material of um size and a gold absorption material of millimeter (mm) size. In addition, the highest level of gold absorbent property is exhibited even compared to a gold absorption material of nanometer (nm) size.

In addition, as the alkylamine compound of a high molecular weight is immobilized on a PAN surface with low graft density, the degradation of crystallinity and strength of a PAN fiber is suppressed while the gold absorbent property is improved. In addition, the absorption selectivity on gold ions is excellent as a solution to be treated is acidified to allow selective absorption of only gold ions in a negative ionic state.

### BRIEF DESCRIPTION OF THE DRAWINGS

FIG. 1 is a schematic view of a PAN fiber-based gold absorption material according to one embodiment of the present invention.

FIGS. 2A, 2B, 2C, and 2D are schematic views illustrating alkylamine compounds of various molecular weights being immobilized to a PAN fiber surface.

FIG. 3 is a schematic view illustrating the introduction of bPEI onto the PAN fiber surface by an amination reaction.

FIG. 4A is an FT-IR analysis result of a gold absorption material immobilized with DETA, TETA, TEPA, and bPEI, respectively, manufactured according to Experimental Example 1.

FIG. 4B illustrates molarity of grafted molecules of each of DETA, TETA, TEPA, and bPEI in the gold absorption material manufactured according to Experimental Example 1.

FIG. 4C illustrates weights of gold absorption materials with DETA, TETA, TEPA, and bPEI immobilized respectively, manufactured according to Experimental Example 1.

FIG. 4D is an XRD analysis result of gold absorption materials with DETA, TETA, TEPA, and bPEI immobilized respectively, manufactured according to Experimental Example 1.

FIG. 4E illustrates tensile strength properties of gold absorption materials with DETA, TETA, TEPA, and bPEI immobilized respectively, manufactured according to Experimental Example 1.

FIG. 4F is a result of measuring maximum absorption capacity of gold absorption materials with DETA, TETA, TEPA, and bPEI immobilized respectively, manufactured according to Experimental Example 1.

FIGS. 5A, 5B, 5C, and 5D are experimental results illustrating the change in the characteristics of the gold absorption material depending on amination reaction time.

FIGS. 6A, 6B, 6C, 6D, 6E, and 6F are experimental results illustrating the gold recovery according to pH of a solution in which gold ions are present.

FIGS. 7A, 7B, 7C, 7D, 7E, 7F, 7G, 7H, 7I, 7J, 7K, and 7L are experimental results illustrating a gold recovery rate according to a concentration of gold ions.

FIG. 7M is a result of an isothermal absorption experiment of a gold absorption material according to Ci.

FIG. 7N is a schematic view summarizing maximum absorption capacity results of the gold absorption material according to the present invention and the publicly known gold absorption material.

FIG. 8 is an experimental result illustrating gold recovery characteristics in an environment where gold ions coexist with 14 metallic ions.

FIG. 9 is an experimental result illustrating the regeneration characteristics of the gold absorption material according to the present invention.

FIG. 10A is an experimental result illustrating the pressure drop characteristics of the gold absorption material according to the present invention.

FIG. 10B is a photograph illustrating the gold absorption material according to the present invention woven into an arbitrary shape.

FIG. 11 is a microscope image on gold absorption materials with bPEIs of molecular weights of 10,000, 25,000, and 70,000 g/mol immobilized, respectively.

### DETAILED DESCRIPTION OF THE INVENTION

Hereinafter, with reference to the drawings, a PAN fiber-based gold absorption material according to one embodiment of the present invention, a method of manufacturing the same, and a method of recovering gold using the same will be described in detail.

### PAN Fiber-Based Gold Absorption Material

The present invention presents a technology that not only can implement very excellent gold recovery characteristics using the gold absorbent property of alkylamine, but also improves the durability of a gold absorption material by suppressing the high water solubility of alkylamine.

As described above in the “description of the related art,” the excellent gold absorbent property of alkylamines are known (see Non-patent Document 2), and how to limit the high water solubility of alkylamines may be a key in terms of the usage as a gold absorption material. As one method of limiting the high water solubility of alkylamines, the present inventors have presented the technology disclosed in Patent Document 5.

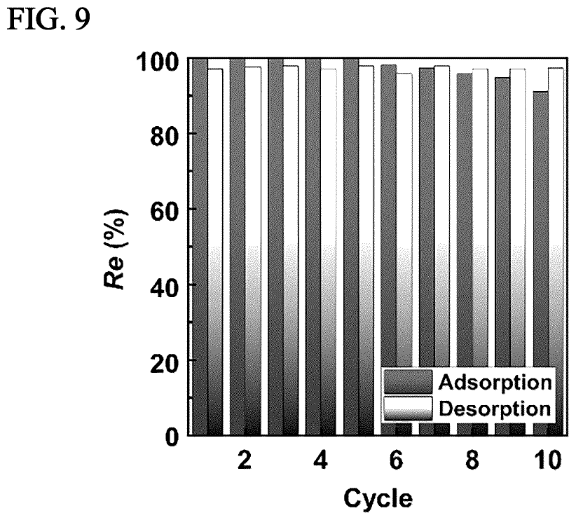

As a continuation of the technology disclosed in Patent Document 5, the present inventors have developed a gold absorption material having an easier manufacturing method, more excellent gold absorbent property, more excellent durability, and more excellent usability.

Whereas the maximum absorption capacity of the gold absorption material disclosed in Patent Document 5 is less than 600 mg/g (see FIG. 9A and FIG. 9B of Patent Document 5), the maximum absorption capacity of the gold absorption material according to the present invention is 1463 mg/g, which is more than two times better (see Experimental Example 4 described below). The maximum absorption capacity of the gold absorption material according to the present invention may be the highest level of gold absorbent property not only compared to a fibrous gold absorption material, but also compared to a nanometer (nm) sized gold absorption material that exhibits relatively excellent gold absorbent property based on the high specific surface area (see Experimental Example 4 and Table 2 described below). In addition, while the gold absorption material of Patent Document 5 is a granular material with a size of millimeter (mm), the gold absorption material according to the present invention may be woven into various shapes such as pellets and the like, as the gold absorption material according to the present invention is a fibrous material with a diameter of μm size, thus broadening the usability. Among other things, while Patent Document 5 presents a structure in which radial pores are formed in the interior of the gold absorption material to suppress the water solubility of the amine functional groups and the amine functional groups are immobilized in the pores, the present invention may be considered an advanced technology in that the water solubility of the alkylamine may be effectively suppressed while manufacturing the gold absorption material in a very simple way.

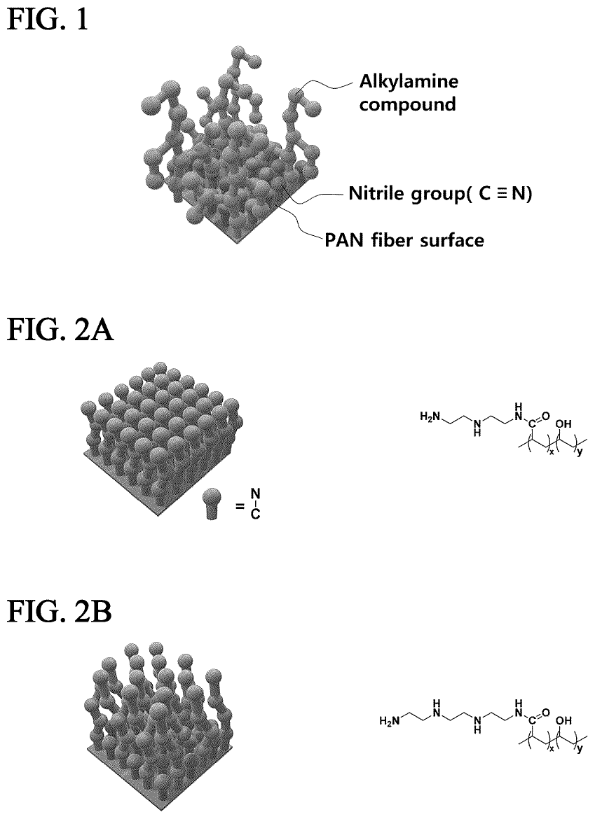

The gold absorption material according to the present invention is configured with a structure in which an alkylamine compound is immobilized on a surface of a polyacrylonitrile fiber (hereinafter referred to as “PAN fiber”) having a diameter of μm size (see FIG. 1). The alkylamine compounds immobilized on the surface of the PAN fiber include various amine functional groups such as primary amine, secondary amine, tertiary amine, and the like, which exhibit excellent gold absorbent property, and the water solubility of the alkylamine compounds is suppressed as the alkylamine compounds are immobilized on the PAN fiber in a state where the crystallinity of the PAN fiber is not damaged.

The technology for immobilizing amine functional groups on the surface of the PAN is known in the art, and the PAN with the amine functional groups immobilized is being used as an absorption material for various applications. Representatively, as disclosed in Patent Document 6, the PAN with amine functional groups immobilized is being used for capturing carbon dioxide.

Although the gold absorption material according to the present invention has a structure in which an alkylamine compound is immobilized on the PAN fiber similar to the known art, the technical reason having an advance over the known art is that the gold absorption material has a structure in which the water solubility of the alkylamine is suppressed and has high gold absorbent property.

In the case of the known PAN technology in which the amine functional group is immobilized, as shown in Patent Document 6, the absorption material is exposed under an atmospheric environment, and the high water solubility of alkylamine is not a characteristic to be considered in the manufacturing of the absorption material. That is, the high water solubility of the alkylamine does not affect the characteristics as a carbon dioxide absorption material, which is according to the method that the absorption material is exposed to the atmospheric environment and carbon dioxide is captured by the alkylamine.

In contrast, when the PAN with the alkylamine compound immobilized is used as the gold absorption material for adsorbing gold ions in water, the high water solubility of the alkylamine has a very important effect on whether the PAN is used as the gold absorption material. To suppress the high water solubility of alkylamine, it is necessary to stably immobilize the alkylamine on a support. For example, the PAN needs to form a stable chemical bond with the alkylamine.

As described above, it is possible to suppress the high water solubility of alkylamine through a stable chemical bond between the PAN and the alkylamine, and the high water solubility of alkylamine is closely related to the crystallinity of the PAN. That is, even though the PAN and the alkylamine form a stable chemical bond, when the crystallinity of the PAN is damaged due to the bonding of the PAN and the alkylamine, the mechanical strength, such as tensile strength, is reduced, and the gold absorption material is forced to be dissolved in a strongly acidic environment.

Therefore, the chemical bonding of the PAN with the alkylamine needs to be induced within an extent that the damage to the crystallinity of the PAN is minimized, so that the dissolution of the gold absorption material may be prevented while the high water solubility of the alkylamine is suppressed.

Nitrile groups (—C≡N) are distributed in a uniform density on the surface of the PAN fiber. The alkylamine compound is immobilized (grafted) onto the PAN fiber in a form in which the amine functional group of the alkylamine compound substitutes the nitrile group (—C≡N). The crystallinity of the PAN fiber is determined by the degree of substitution of the nitrile group (—C≡N) with alkylamine compound. That is, as the rate of the nitrile group (—C≡N) on the PAN fiber surface substituted by the alkylamine compound increases, the crystallinity of the PAN decreases. In contrast, as the graft density of the alkylamine compound increases, the crystallinity of the PAN decreases. Accordingly, it is necessary to reduce the graft density of alkylamine compound to suppress the water solubility of alkylamine compound.

Meanwhile, the high water solubility of the alkylamine compound may be suppressed while the crystallinity degradation of the PAN may be alleviated by reducing the graft density of the alkylamine compound. However, the decrease in the graft density of the alkylamine compound reduces the number of amine functional groups that are able to adsorb gold ions in water, which leads to a decrease in the gold absorbent property.

As a solution on this, the present invention introduces an alkylamine compound with a high molecular weight of 25,000 g/mol or more, which may cause steric hindrance, thereby enabling the expression of excellent gold absorbent property while reducing the graft density of the alkylamine compound. With reference to Table 1 of Experimental Example 3 described below, when an alkylamine compound with a molecular weight of less than 25,000 g/mol is applied, excellent gold absorbent property cannot be expected due to poor strength properties.

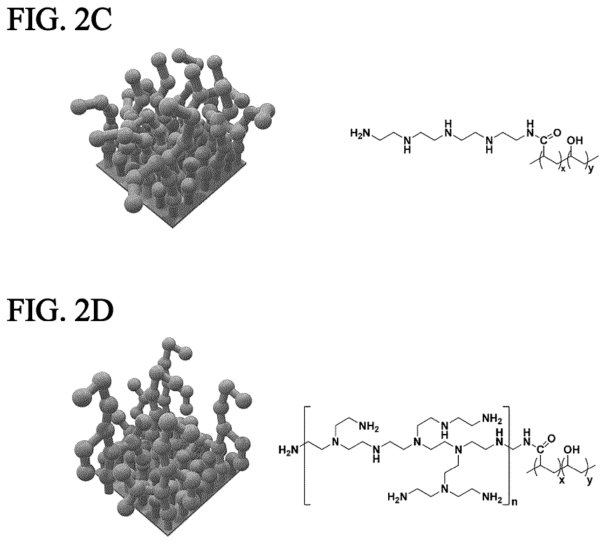

When the alkylamine compound of high molecular weight is introduced, due to the large molecular size of the alkylamine compound, a repulsive force, that is, steric hindrance, occurs between the alkylamine compounds in close proximity upon reaction of the nitrile group (—C≡N) of the PAN surface with the alkylamine compound, and finally, the alkylamine compounds immobilized on the PAN surface are formed to be spaced apart from each other by a predetermined distance. That is, the nitrile groups (—C≡N) that are not bonded to the alkylamine compounds will be present between the alkylamine compounds immobilized on the PAN surface, which means that the graft density of the alkylamine compounds will be lower. With reference to the schematic views of FIG. 2A to FIG. 2D, in the case that DETA, which is an alkylamine compound of low molecular weight, is introduced (see (a)), while the DETA is immobilized on the PAN surface with a high graft density in the form of a one-to-one matching with the nitrile groups (—C≡N) on the PAN surface, the graft density of the alkylamine compound decreases due to steric hindrance between the alkylamine molecules as the molecular weight of the alkylamine compound increases (TETA<TEPA<bPEI), as illustrated in (b) to (d) of FIG. 2.

Meanwhile, the alkylamine compound of high molecular weight has a much higher number of amine functional groups compared to the alkylamine compound of low molecular weight. Therefore, it is possible to improve the gold absorbent property while reducing the graft density of the alkylamine compound through the introduction of the alkylamine compound with a high molecular weight.

A branched alkylamine compound may be used as an alkylamine compound with a molecular weight of 25,000 g/mol or more. In addition, the branched alkylamine compound may be any one of branched poly (ethyleneimine) (bPEI), iso-buthylamine, sec-buthylamine, iso-amylamine, phosphoethanolamine (PEA), trimethylamine, iso-propylamine, or a combination thereof.

The PAN fiber in which the alkylamine compound is immobilized is obtained by polymerization of acrylonitrile and spinning of polyacrylonitrile obtained by the polymerization, and various PAN fibers manufactured by this process are applicable to the present invention. In addition, a diameter of the PAN fiber applied in the present invention is not limited in value, but may be 1 to 500 μm in diameter in one embodiment. For reference, the PAN fiber with a diameter of 50 μm was used in Experimental Examples 1 to 5 described below.

### Method of Manufacturing PAN Fiber-Based Gold Absorption Material

An aqueous solution of alkylamine in which the alkylamine compound is dissolved is prepared, and the PAN fiber is mixed in the aqueous solution of alkylamine to induce an amination reaction. By the amination reaction, the alkylamine compound is immobilized on the PAN fiber surface in the form of substitution of the nitrile group (—C≡N) of the PAN fiber surface with the amine functional group of the alkylamine compound. That is, a layer of alkylamine compound with a predetermined thickness is formed on the PAN fiber surface by the amination reaction.

The amine functional group of the alkylamine compound is meant to be inclusive of a variety of functional groups that includes an amine group (—NH₂), and, for example, may mean one of primary amine, secondary amine, tertiary amine, quaternary amine, or a combination thereof.

A non-metallic Lewis acid catalyst or a metallic Lewis acid catalyst may be added to the aqueous solution of the alkylamine to promote the amination reaction. As the non-metallic Lewis acid catalyst, one of BF₃·2H₂O, acetic acid, or hydrochloric acid may be used, and AlCl₃·6H₂O may be used as the metallic Lewis acid catalyst.

The amination reaction may be achieved through mixing the PAN fiber in the aqueous solution of the alkylamine, and the hydrothermal synthesis may be induced by heating to a predetermined temperature to promote the amination reaction. In one embodiment, the amination reaction may be induced through the hydrothermal synthesis by loading the aqueous solution of the alkylamine and the PAN fiber in an autoclave.

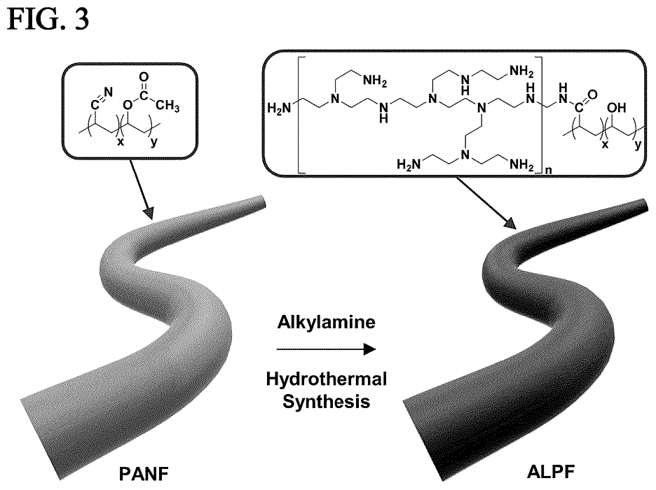

In a state in which an alkylamine compound is immobilized on the PAN fiber surface by the amination reaction, when the unreacted alkylamine compound on the PAN fiber surface is removed using ultrapure water and chemicals, the method of manufacturing the PAN fiber-based gold absorption material according to one embodiment of the present invention has been completed. FIG. 3 is a schematic view illustrating the introduction of bPEI onto the PAN fiber surface by the amination reaction.

### Method of Recovering Using PAN Fiber-Based Gold Absorption Material

First, a solution to be treated in which gold ions are present is acidified.

With reference to Experimental Example 4 described below, the gold recovery efficiency increases as the acidity of the solution to be treated increases, and preferably the pH of the solution to be treated needs to be maintained at 4 or less. The acidification of the solution to be treated may be controlled by introducing weak or strong acid to the solution to be treated. In addition to the gold ions, up to 14 metallic ions, including copper (Cu), nickel (Ni), cobalt (Co), and zinc (Zn), may coexist with the gold ions in the solution to be treated.

Then, the PAN fiber-based gold absorption material according to the present invention is added to the solution to be treated under an acidic condition, and the gold ions present in the solution to be treated are made to be adsorbed on the gold absorption material.

When the gold absorption material of the present invention is added to the solution to be treated under the acidic condition, the amine functional groups present in the alkylamine compound are electrically formed in a (+) polar state by combining with hydrogen ions (H+), and the gold ions are formed in a (−) polar state by combining with negative ions, for example, chlorine ions (Cl⁻). Meanwhile, other metallic ions present in the solution to be treated, such as copper (Cu), nickel (Ni), cobalt (Co), zinc (Zn), and the like, remain in a positive ionic state even under the acidic condition.

Accordingly, the gold ions in the (−) polar state are adsorbed to the amine functional groups in the (+) polar state, while other metallic ions that remain in the positive ionic state are not adsorbed to the amine functional groups in the (+) polar state. In addition, the gold ions in the (−) polar state adsorbed to the amine functional groups in the (+) polar state are crystallized and grown in the metallic form (Au⁰ ) by a reduction reaction. With reference to Experimental Example 4 described below, the gold reduced to the metallic form (Au⁰ ) crystallizes in the form of brick by brick on the PAN fiber surface.

With reference to Experimental Example 4 described below, it is shown that even if 0.5 g/L of the PAN fiber-based gold absorption material according to the present invention is added into an environment in which gold ions at a concentration of 0.1 ppm are present, the gold recovery efficiency is close to 100%. These results show a significant improvement in the gold recovery characteristics compared to the gold absorption material of Patent Document 5, which exhibits the gold recovery efficiency of approximately 80% using 1 g/L of gold absorption material in the environment with gold ions at a concentration of 0.1 ppm.

In addition, the maximum absorption amount of the gold absorption material according to the present invention was shown to be 1463 mg/g, which is an excellent result by more than 2 times compared to the maximum absorption amount of the gold absorption material of Patent Document 5 (less than 600 mg/g), which demonstrated the best gold absorbent property among millimeter (mm) sized gold absorption materials, and is also the best gold absorbent property even compared to nanometer sized gold absorption materials. Further, in an environment where gold ions and 14 kinds of metallic ions coexist, the gold absorption material of the present invention shows the gold recovery efficiency of 99.4% or more even when the concentration of the 14 kinds of metallic ions is 100 times higher than the concentration of gold ions.

Meanwhile, the PAN fiber-based gold absorption material of the present invention, in which the absorption of gold ions has been completed, may be regenerated by being added into an aqueous solution in which thiourea and HCl are mixed. When the gold absorption material with the gold ions adsorbed is added into the aqueous solution in which thiourea and HCl are mixed, the gold is eluted, and then the gold absorption material is washed with NaOH and the like, and the regeneration of the gold absorption material has been completed.

The PAN fiber-based gold absorption material according to the present invention shows the gold recovery efficiency of 90% or more even if the absorption and regeneration of gold ions is repeated. With reference to Experimental Example 4 described below, the gold recovery efficiency is maintained close to 100% when the absorption and regeneration of gold ions is repeated 5 times, and the gold recovery efficiency is 90% or more even when the absorption and regeneration of gold ions is repeated 10 times.

In the above, the PAN fiber-based gold absorption material, the method of manufacturing the same, and the method of recovering gold using the same according to one embodiment of the present invention have been described. Hereinafter, the present invention will be described more specifically through experimental examples.

### Experimental Example 1: Manufacturing of PAN Fiber-Based Gold Absorption Material

Aqueous solutions of various alkylamine compounds in which each of the alkylamine compounds, that is, DETA (99%, Sigma Aldrich), TETA (97%, Sigma Aldrich), TEPA (technical grade, Sigma Aldrich), or bPEI (molecular weight 70,000 g/mol, 30% aqueous solution, Alfa Aesar) was dissolved at a concentration of 10 wt % were prepared. Then, 5 g of PAN fiber was added into 70 ml of each alkylamine aqueous solution and swollen for one hour, and then transferred to a 100 mL of high-pressure autoclave, and left at 160° C. for 6 hours after BF₃·2H₂O, which is an amination reaction catalyst, was further added. The PAN fiber whose reaction has been completed was washed sequentially with ultrapure water, 1 M HCl solution, NaOH solution, and ultrapure water to remove unreacted alkylamine molecules, and then dried at 80° C. for 24 hours.

### Experimental Example 2: Analysis of Crystallinity and Strength Properties of PAN Fiber-Based Gold Absorption Material

The effect of the molecular weight of the alkylamine compound and the graft density of the alkylamine compound on the crystallinity and strength properties of the PAN fiber-based gold absorption material was analyzed.

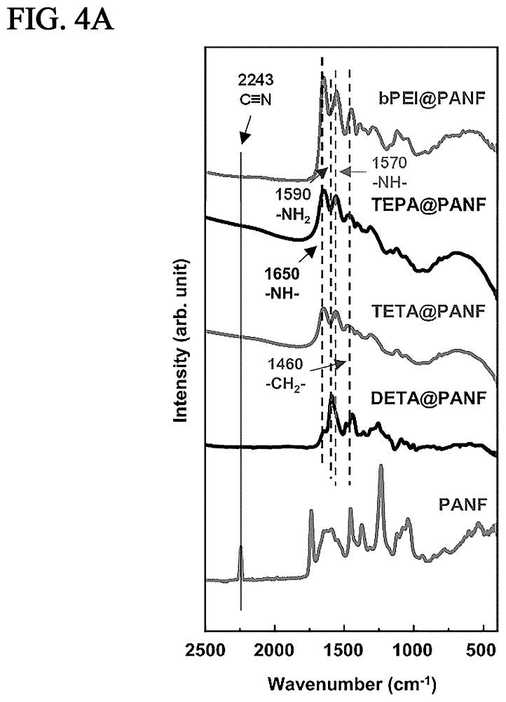

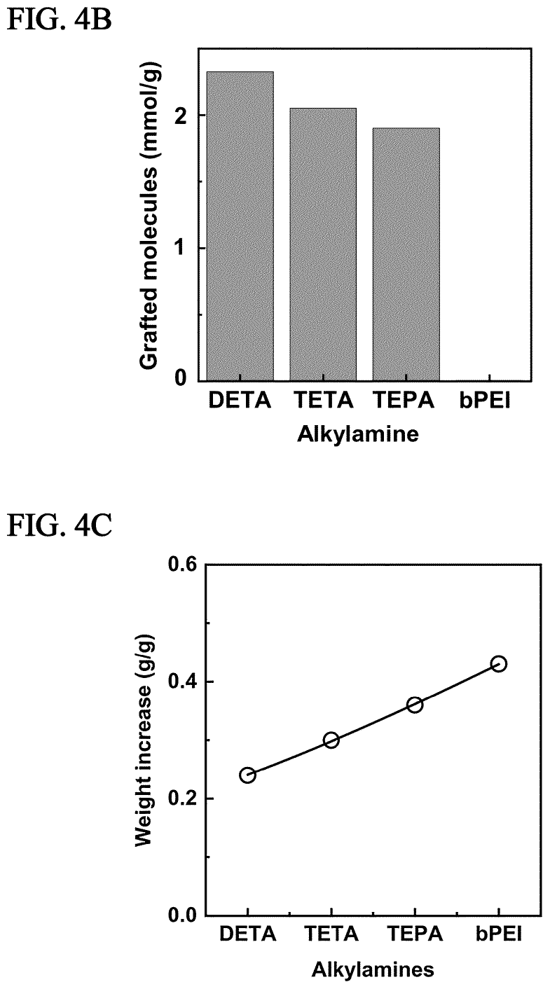

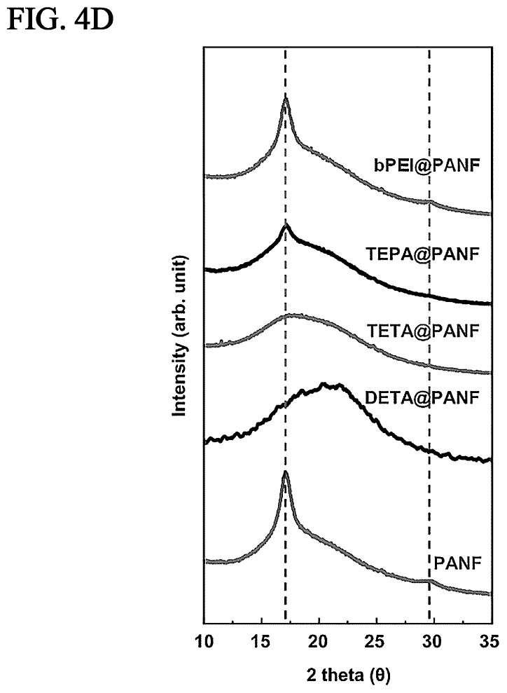

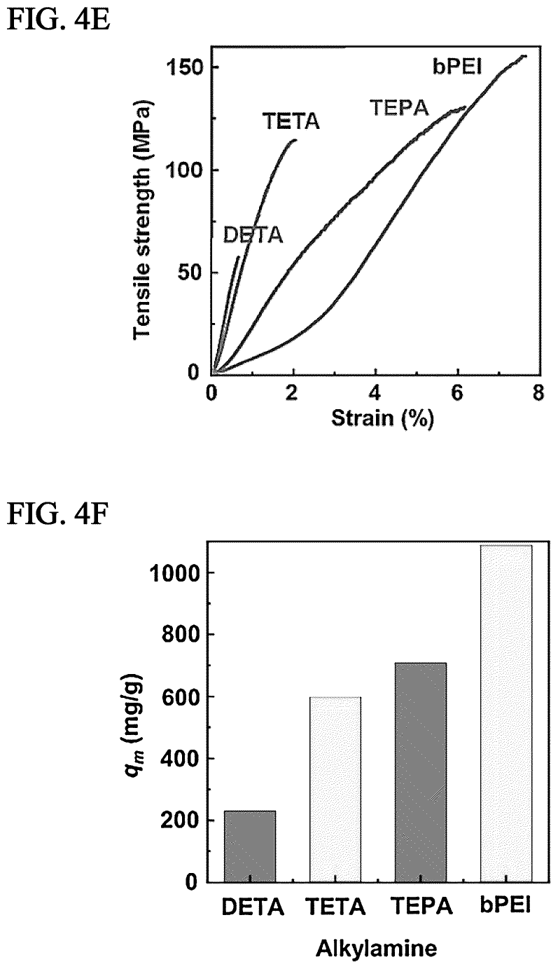

FIG. 4A is an FT-IR analysis result of a gold absorption material immobilized with DETA, TETA, TEPA, and bPEI, respectively, manufactured according to Experimental Example 1, FIG. 4B illustrates molarity of grafted molecules of each of DETA, TETA, TEPA, and bPEI in the gold absorption material manufactured according to Experimental Example 1, and FIG. 4C illustrates weights of gold absorption materials with DETA, TETA, TEPA, and bPEI immobilized respectively, manufactured according to Experimental Example 1. In addition, FIG. 4D is an XRD analysis result of gold absorption materials with DETA, TETA, TEPA, and bPEI immobilized respectively, manufactured according to Experimental Example 1, FIG. 4E illustrates tensile strength properties of gold absorption materials with DETA, TETA, TEPA, and bPEI immobilized respectively, manufactured according to Experimental Example 1, and FIG. 4F is a result of measuring maximum absorption capacity of gold absorption materials with DETA, TETA, TEPA, and bPEI immobilized respectively, manufactured according to Experimental Example 1.

With reference to FIG. 4A, it can be seen that a 1590 cm⁻¹ peak corresponding to primary amine (—NH₂) is observed in the case of the gold absorption material with the DETA immobilized (DETA@PANF). This is the result of the primary amine (—NH₂), which has a relatively short length and is linear, being easily immobilized on the PAN fiber surface. In contrast, a 1650 cm⁻¹ peak and a 1570 cm⁻¹ peak corresponding to the secondary amine (—NH—) were observed in the case of the gold absorption materials with the TETA, TEPA, and bPEI whose molecular weights are larger than the DETA immobilized (TETA@PANF, TEPA@PANF, bPEI@PANF). The predominance of secondary amines (—NH—) observed means that alkylamines with high molecular weight and branched alkylamines were immobilized on the PAN fiber, which means that the graft density of the TETA, TEPA, and bPEI is lower than that of the DETA.

This tendency of graft density is more clearly identified through the result of measuring the molarity of grafted molecules (mmol/g) in FIG. 4B. With reference to FIG. 4B, it can be seen that as the molecular weight of the alkylamine compound immobilized on the gold absorption material increases (DETA<TETA<TEPA<bPEI), the molarity of the grafted molecules of the alkylamine compound introduced to the PAN fiber surface decreases. In particular, it was shown that the molarity of the grafted molecules converged to zero in the case of the gold absorption material with the bPEI introduced, which is because the molecular weight of the bPEI (70,000 g/mol) is much larger than those of the DETA, TETA, and TEPA. When these results are considered together with the weight measurement result of the gold absorption materials in FIG. 4C, it is shown that the weight of the gold absorption material tends to increase with the increase of the alkylamine compound, which means that the weight of the gold absorption material with the bPEI introduced is the largest due to the large molecular weight of the bPEI, despite the graft density of the bPEI is low, that is, despite the molarity of grafted molecules of the bPEI is small.

As described above, the results of the molecular weight and graft density of the alkylamine compound have a direct effect on the crystallinity and strength properties of the gold absorption material.

With the consideration of the XRD analysis result in FIG. 4D, it can be seen that the 16.8 and 29.2 peaks, which are the unique peaks of the PAN fiber, disappear or are attenuated by the introduction of alkylamine compound in the case of the gold absorption materials with the DETA, TETA and TEPA introduced (DETA@PANF, TETA@PANF, TEPA@PANF). In contrast, the unique peak of the PAN fiber is maintained in the case of the gold absorption material with the bPEI introduced (bPEI@PANF). These results mean that the crystallinity of the PAN fiber decreases as the substitution rate of nitrile groups (—C≡N) on the PAN fiber surface increases due to the graft density of alkylamine compound being higher. In addition, the degradation of crystallinity of the PAN fiber is suppressed as the graft density of the alkylamine compound decreases.

The crystallinity of the PAN fiber is directly related to the strength properties of the gold absorption material, which may be identified through the tensile strength properties in FIG. 4E. As illustrated in FIG. 4E, it can be seen that the tensile strength of the gold absorption material increases as the molecular weight of the alkylamine compound increases, that is, as the graft density of the alkylamine compound decreases. In particular, in the case of the gold absorption material with the bPEI introduced, it can be seen that the tensile strength properties is 150 MPa at a strain rate of approximately 8%, thus exhibiting a superior tensile strength properties compared to other gold absorption materials.

With the results analyzed above, it can be seen that the crystallinity and strength properties of the gold absorption material are better as the graft density of the alkylamine compound decreases due to the molecular weight of the alkylamine compound being larger.

Further, the crystallinity and strength properties of the gold absorption material have the same tendency as the gold absorption characteristics of the gold absorption material. With reference to FIG. 4F, it can be seen that the maximum absorption capacity of the gold absorption material increases as the graft density of the alkylamine compound decreases, consistent with the tendency of the crystallinity and strength properties of the gold absorption material. In particular, the gold absorption material with the bPEI introduced shows the maximum absorption capacity of 1463 mg/g.

### Experimental Example 3: Gold Absorbent Property of Gold Absorption Material According to Introduction Amount of bPEI

With Experimental Example 2, it was confirmed that the graft density of the alkylamine compound decreases as the molecular weight of the alkylamine compound increases, and the degradation of the crystallinity of the PAN fiber is suppressed as the graft density of the alkylamine compound decreases, thereby securing an excellent strength properties of the gold absorption material, thus, the gold absorbent property of the gold absorption material with the bPEI introduced exhibiting the best result.

In Experimental Example 3, an experiment was proceeded to examine an optimal condition for introducing the bPEI. The amination reaction condition in Experimental Example 1 was left at 160° C. for 6 hours, and the amination reaction time was applied for 0 to 8 hours under the same temperature condition, and the results were examined. The other experimental conditions were the same as in Experimental Example 1.

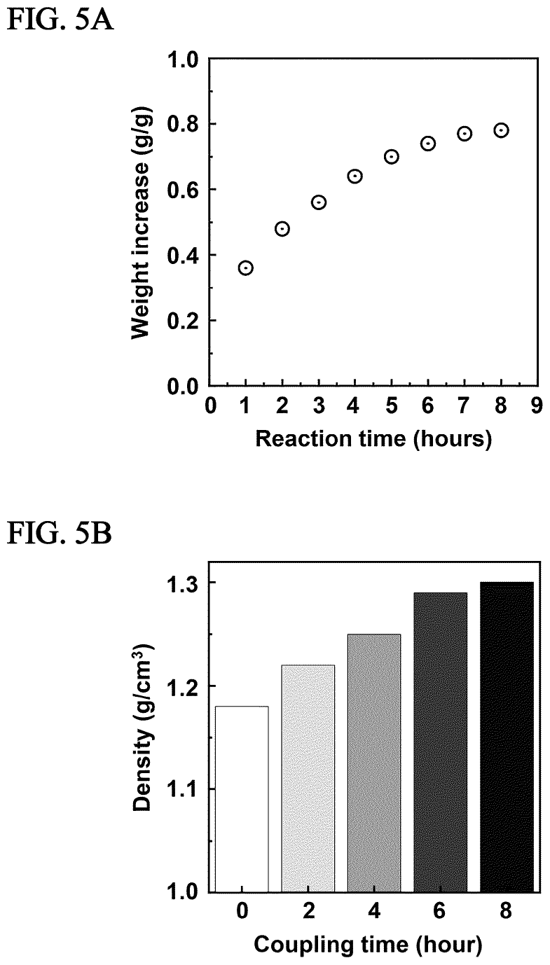

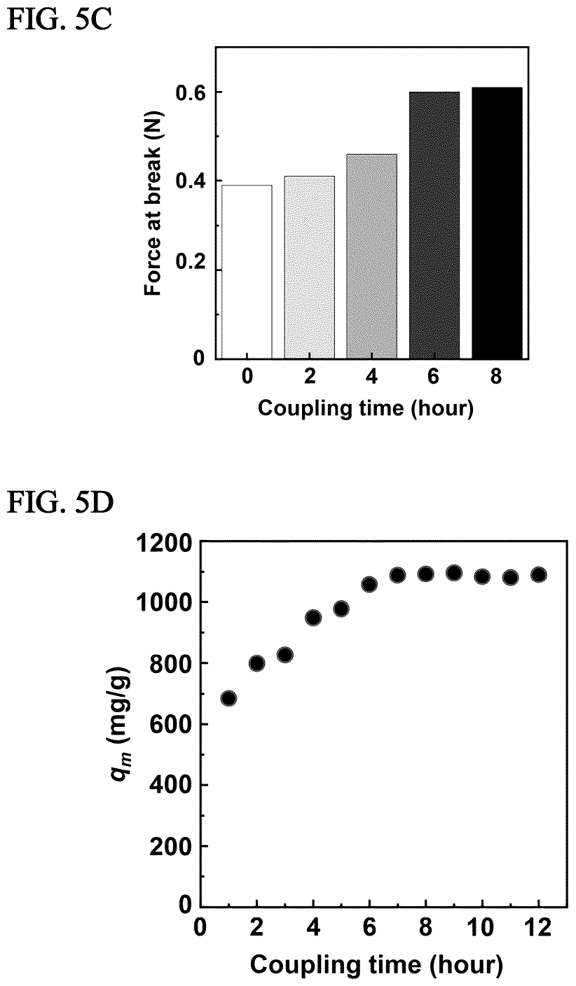

FIG. 5A illustrates a change in the weight of the gold absorption material according to the amination reaction time, FIG. 5B illustrates a change in the density of the gold absorption material according to the amination reaction time, FIG. 5C illustrates a change in the strength of the gold absorption material according to the amination reaction time, and FIG. 5D illustrates a change in the maximum absorption capacity of the gold absorption material according to the amination reaction time.

With reference to FIG. 5A and FIG. 5B, it can be seen that the weight and density of the gold absorption material increases as the amination reaction time increases. In addition, as illustrated in FIG. 5C, the strength of the gold absorption material showed a tendency to increase as the amination reaction time increases; however, there was no change in the strength after an occasion when the amination reaction time elapsed for 6 hours. In the case of the gold absorbent property, as illustrated in FIG. 5D, the maximum absorption capacity of the gold absorption material showed a tendency to increase with the amination reaction time increasing, and equilibrium was reached after an occasion when the amination reaction time elapsed for 7 hours. This means that the amination reaction between the PAN fibers of the bPEI is terminated at an occasion when 7 hours have elapsed.

When these results of FIG. 5C and FIG. 5D are related to the measurement result of the molarity of grafted molecules in FIG. 4B, it can be seen that at the occasion when the amination reaction is terminated, the gold absorption materials with the DETA, TETA, and TEPA immobilized respectively, show a result in which the molarity of grafted molecules exceeds 1.75 mmol/g, while the gold absorption material with the bPEI immobilized shows that the molarity of grafted molecules is less than 1 mmol/g, more precisely, the molarity of grafted molecules converges to zero.

With the experimental results above, it can be seen that the excellent crystallinity and strength properties are exhibited while the molarity of grafted molecules of the alkylamine compound decreases as the molecular weight of the alkylamine compound immobilized on the PAN fiber surface increases, thereby increasing the gold absorbent property, and it was confirmed that the gold absorption material with the bPEI of molecular weight of 70,000 g/mol immobilized on the PAN fiber is an experimental example that conforms to the above.

Meanwhile, in order to identify the effect of the molecular weight of the alkylamine compound on the gold absorption material, the strength properties of the gold absorption material according to the molecular weight of the bPEI were analyzed. As described above, the strength properties of the gold absorption material are directly related to the molarity of the grafted molecules of the alkylamine compound, the crystallinity of the gold absorption material, and the gold absorbent property. Therefore, changes in the various properties of the gold absorption material may be inferred according to the molecular weight of the bPEI through the analysis of the strength properties of the gold absorption material according to the molecular weight of the bPEI.

Table 1 below shows the density, force at break, and elongation at break of the gold absorption material with different molecular weights of bPEI immobilized on the PAN fiber, respectively. In this case, the method of manufacturing the gold absorption material follows the method in Experimental Example 1, and 160° C. and 6 hours were applied for the amination reaction condition.

With reference to Table 1, it can be seen that while the gold absorption material with the bPEI of a molecular weight of 700 to 10,000 immobilized shows the properties of a force at break of 17.5 cN or less and an elongation at break of 3.26% or less, the gold absorption material with the bPEI of a molecular weight of 25,000 applied has an improved strength properties that exhibits a force at break of 89.79 cN and an elongation at break of 12.96%, thereby the strength properties are significantly improved. In addition, it can be seen that the characteristics of a force at break (90.61 cN) and an elongation at break (13.39%) are excellent even in the case of the gold absorption material with the bPEI of molecular weight 75,000 applied. With these results, it can be seen that the application of an alkylamine compound of a molecular weight of 25,000 g/mol or more may improve the strength properties of the gold absorption material. Further, it can be inferred that various characteristics of the gold absorption material, that is, the molarity of grafted molecules, the crystallinity of the gold absorption material, and the gold absorbent property, may be improved through the application of the alkylamine compound of a molecular weight of 25,000 g/mol or more.

Furthermore, FIG. 11 is a micrograph on gold absorption materials with bPEIs of 10,000 (top), 25,000 (center), and 70,000 (bottom) g/mol immobilized, respectively, and it was confirmed that the gold absorption material with the bPEI of a molecular weight of 10,000 immobilized shows a characteristic of fracture due to a low force at break and elongation at break.

TABLE 1
<Strength properties of gold absorption materials with bPEIs
having different molecular weights immobilized>

| bPEI | | | |
|---|---|---|---|
| Molecular | | | |
| Weight | Fiber Density | Force at break | Elongation at break |
| (g/mol) | (g cm-3) | (cN) | (%) |
| 700 | 1.28 | 12.1 | 0.57 |
| 1300 | 1.27 | 12.3 | 1.44 |
| 5000 | 1.28 | 12.8 | 1.01 |
| 10000 | 1.27 | 17.5 | 3.26 |
| 25000 | 1.27 | 89.79 | 12.96 |
| 70000 | 1.28 | 90.61 | 13.39 |

### Experimental Example 4: Gold Recovery Characteristics of Gold Absorption Material with bPEI Introduced

With Experimental Example 3, it was confirmed that the gold absorption material with 7 hours of amination reaction applied has an excellent gold absorbent property, and various gold recovery experiments were proceeded using the gold absorption material manufactured under this condition.

First, the gold recovery rate according to the pH of the solution in which the gold ions are present was examined. Specifically, the gold recovery rate was measured by adjusting the pH of a solution containing 100 ppm of gold ions from 1 to 12 in increments of 1. In this case, the gold absorption material was added at a concentration of 0.5 g/L, and the gold absorption reaction time was applied for 24 hours at room temperature.

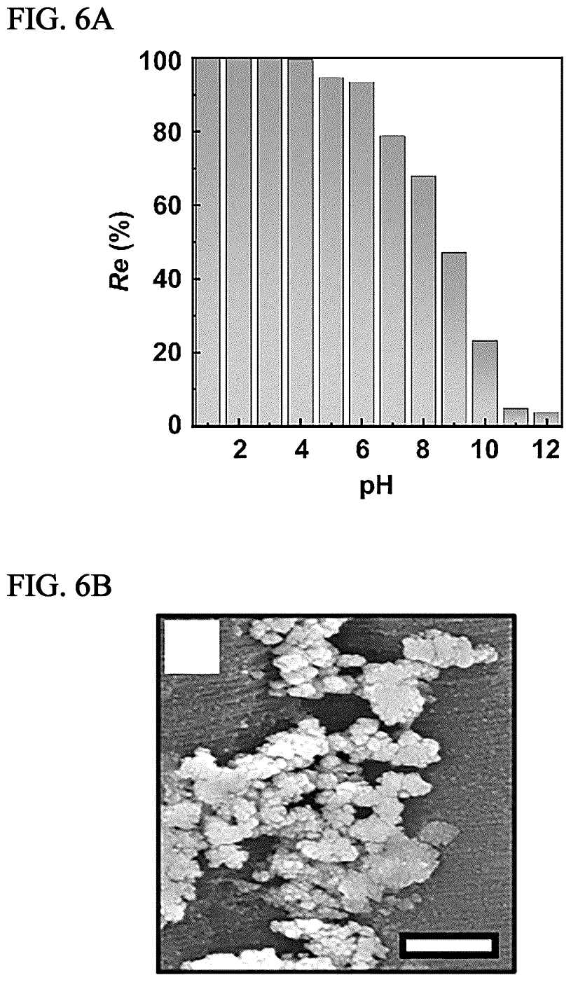

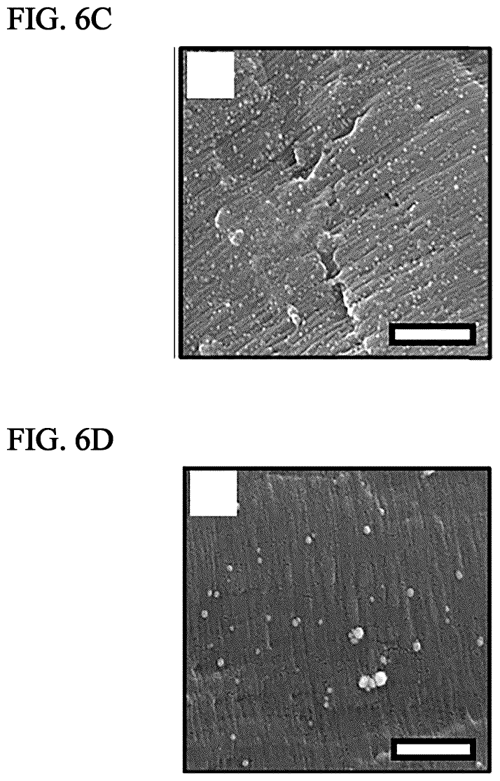

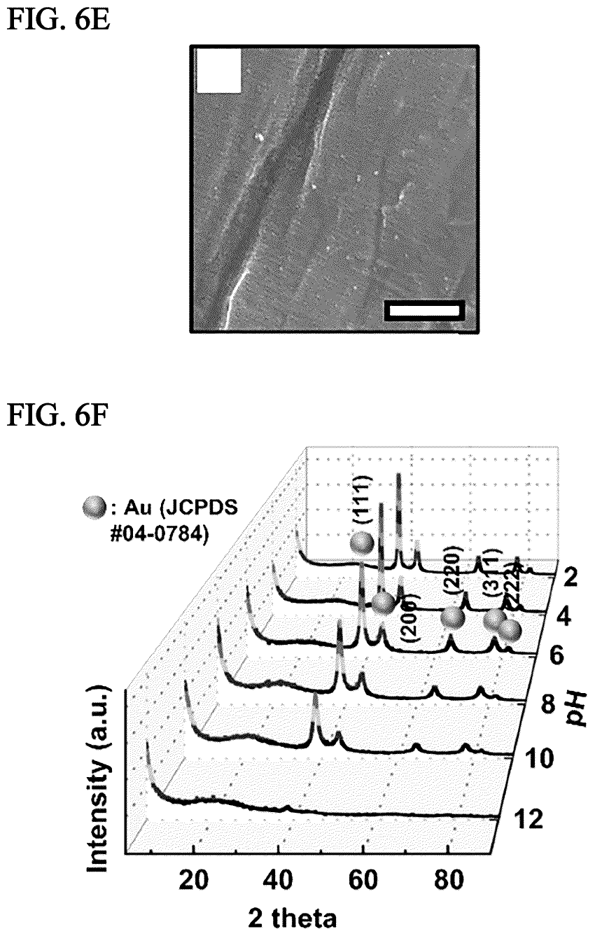

The result of the experiment showed a gold recovery rate of 100% at pH of 4 or less, as illustrated in FIG. 6A. In addition, it was found that the gold recovery rate decreases significantly as pH increases under a condition above pH 4. SEM analysis (see FIG. 6B to FIG. 6E) and XRD analysis (see FIG. 6F) were performed on the gold absorption material where gold absorption proceeded under conditions of pH 1, 4, 8, and 12, and it was confirmed by the results that the adsorbed material was gold (Au).

The gold recovery rate was examined by varying the concentration of gold ions. Specifically, the concentration of gold ions in the solution was set to 0.1, 0.2, 0.5, 1, 2, 5, 10, 100, 500, and 1000 ppm, respectively, and FESEM and EDS analyses were performed along with the measurement of the gold recovery rate.

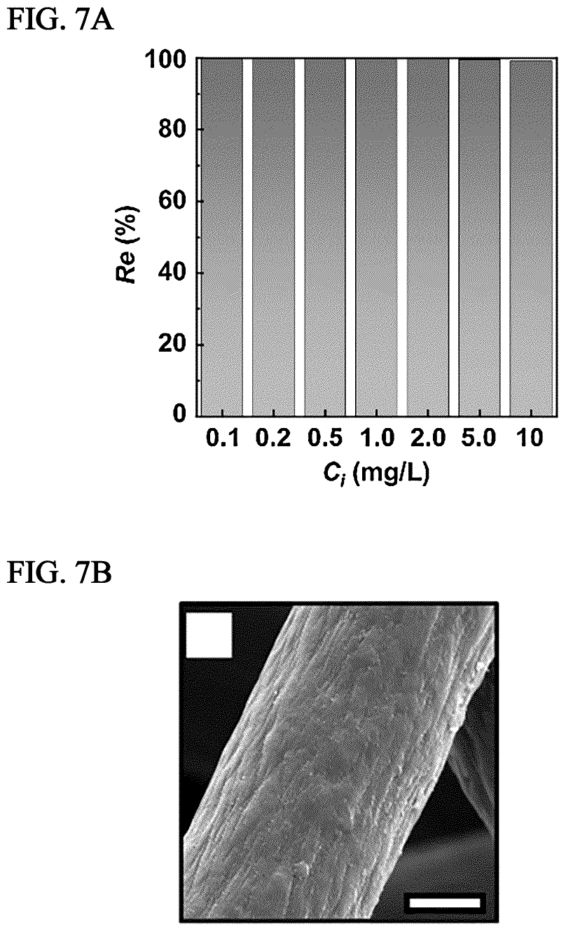

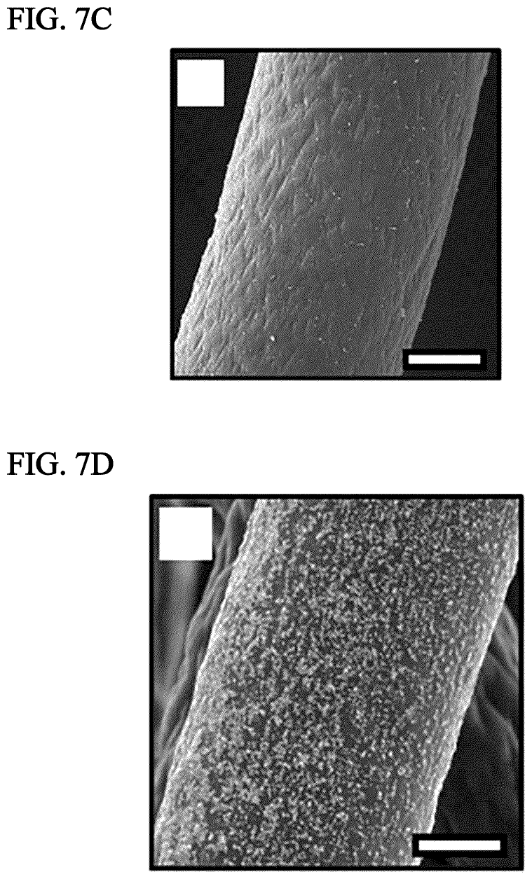

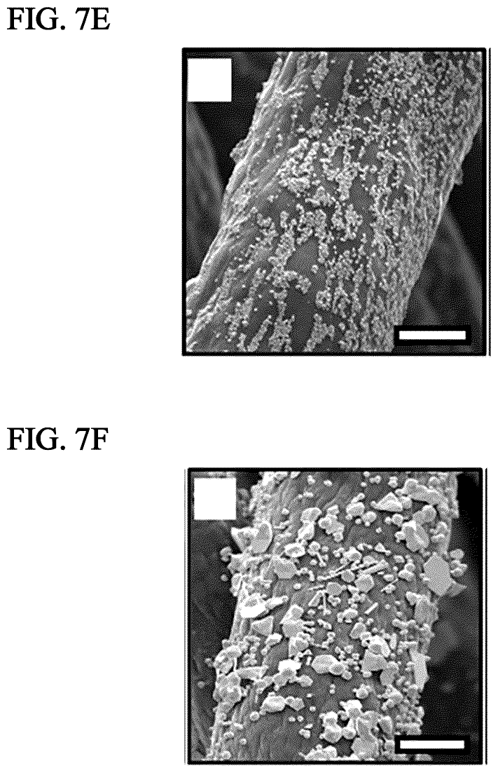

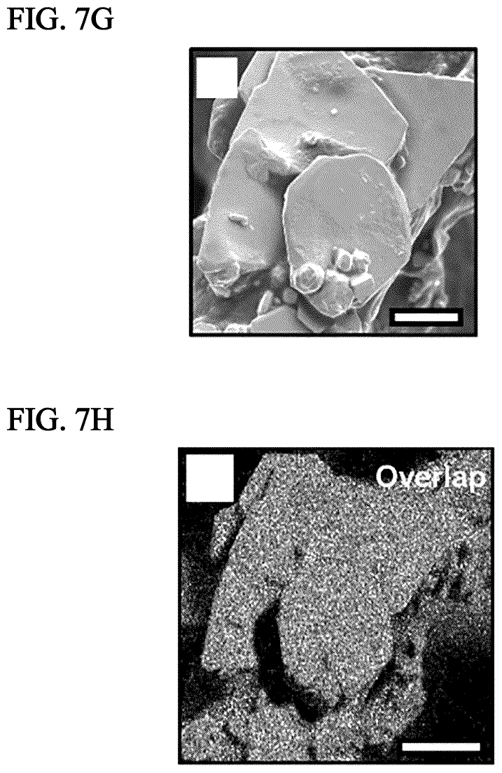

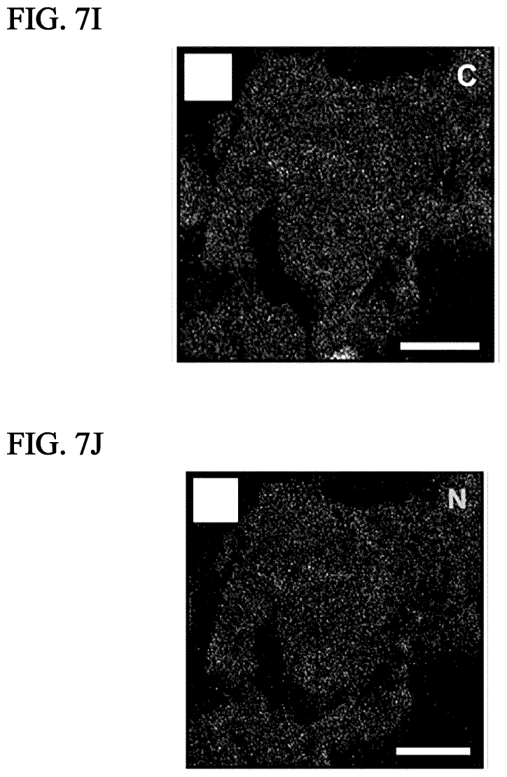

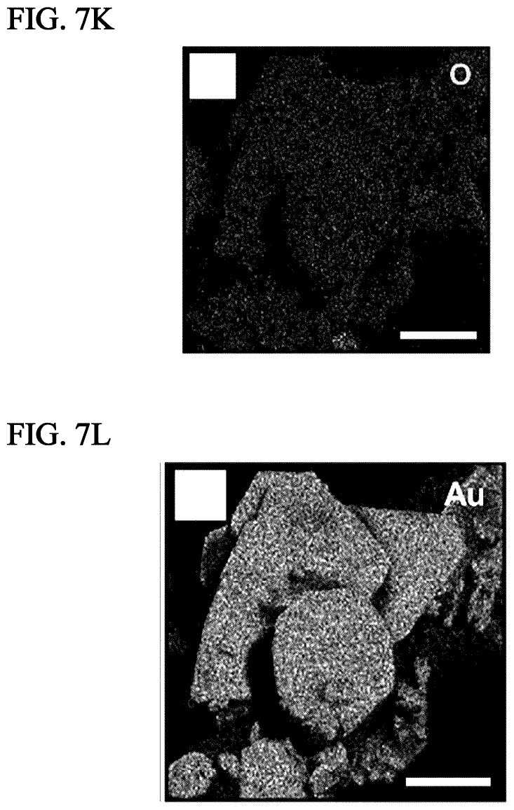

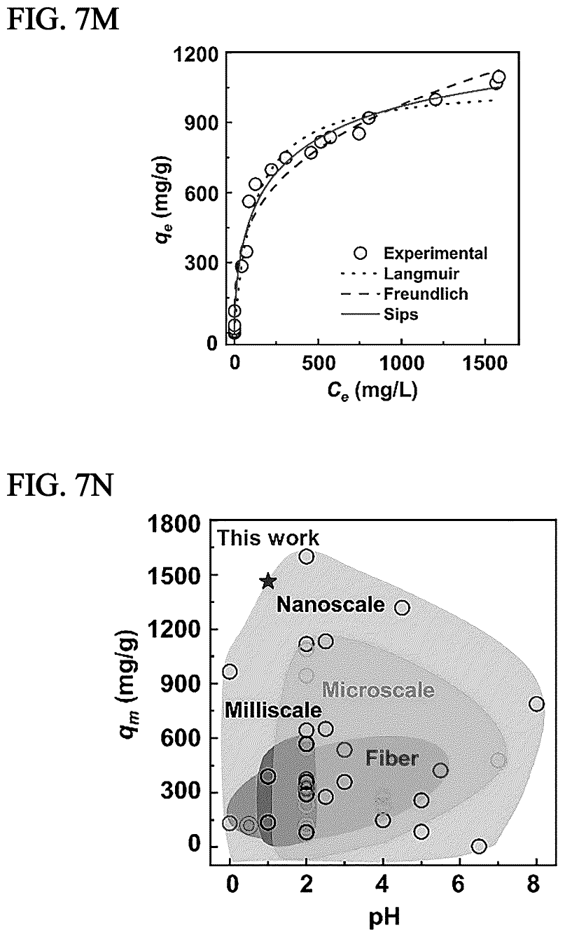

With reference to FIG. 7A, it can be seen that the gold recovery rate reaches 100% even under a condition of low concentration of gold ions of 10 ppm or less. FIG. 7B to FIG. 7G are FESEM images of the gold absorption material proceeded with absorption at concentrations of 0.1, 1, 10, 100, 500, and 1000 ppm of gold ions, and FIG. 7H to FIG. 7L are FESEM-EDS analysis results on the gold absorption material proceeded with absorption at a concentration of 1000 ppm of gold ions, which is a result indicating that the material adsorbed on the gold absorption material is a gold crystal.

In addition, an isothermal absorption experiment was proceeded to measure the maximum absorption capacity of the gold absorption material.

FIG. 7M is the result of the isothermal absorption experiment of the gold absorption material according to Ci, indicating that the absorption capacity (ge, mg/g) of the gold absorption material on gold ions at equilibrium concentration (Ce, mg/L) increases as Ci increases. Isotherm data on gold recovery were fitted using three representative isotherm models, which are Langmuir, Freundlich, and Sips, and the Sips equation gave a good fit to the isotherm data compared to the Langmuir and Freundlich models, and the coefficient of determination (R²) showed a value close to 1 (0.99). The result of calculating the maximum absorption capacity of the gold absorption material according to the Sips model showed a maximum absorption capacity of 1463 mg/g (see Table 2 below).

TABLE 2
Results of isothermal absorption experiment of gold absorption
material according to the present invention

| Langmuir | | | Freundlich | | | Sips | | | |
|---|---|---|---|---|---|---|---|---|---|
| qₘ | K_{L} | R² | n | K_{F} | R² | qₘ | kₛ | N | R² |
| 1068.63 | 0.0086 | 0.94 | 3.21 | 113.68 | 0.97 | 1462.96 | 0.036 | 1.73 | 0.99 |

The characteristic of the maximum absorption capacity of 1463 mg/g of the gold absorption material according to the present invention, despite having a relatively low specific surface area compared to a nano-sized gold absorption material, is a characteristic that is significantly superior to that of a fibrous gold absorption material as well as a micron-sized and millimeter-sized known gold absorption material (see FIG. 7N and Table 3), which may be attributed to the securing of structural stability such as crystallinity and strength properties of the gold absorption material, as described above.

Further, the absorption selectivity experiments of the gold absorption material according to the present invention were proceeded.

In consideration of the coexistence of other metallic ions besides the gold ions in the recovery of gold ions, 14 kinds of metallic ions that are able to coexist with the gold ions were allowed to coexist with the gold ions, on which the gold recovery experiments were proceeded. An initial concentration of gold ions was 10 mg/L, and the concentrations of the coexisting metallic ions were set to 1 (10 mg/L), 10 (100 mg/L), and 100 (1000 mg/L) times the concentration of gold ions, respectively. The absorption time was proceeded at room temperature for 24 hours with stirring at 200 rpm. In addition, the pH of the solution was set to 1. The 14 metallic ions are copper (Cu(II)), chromium (Cr(III)), iron (Fe(III)), aluminum (Al(III)), nickel (Ni(II)), 160 zinc (Zn(II)), cobalt (Co(II)), cadmium (Cd(II)), lead (Pb(II)), manganese (Mn(II)), sodium (Na(I)), potassium (K(I)), magnesium (Mg(II)), and calcium (Ca(II)) ions (ACS reagent, Sigma Adrich) in nitrate form.

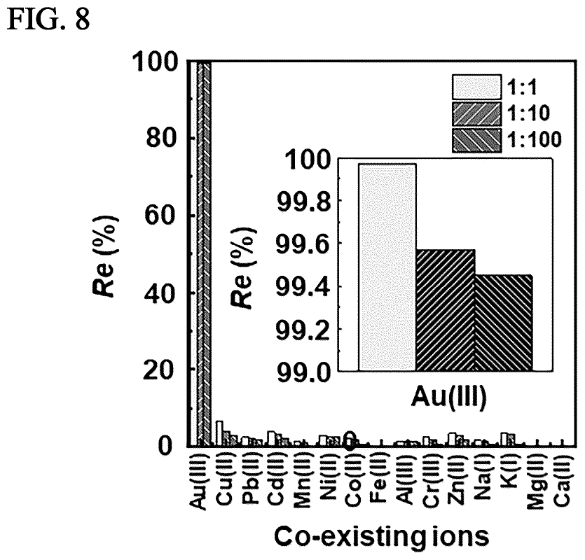

As illustrated in FIG. 8, the results of the gold recovery experiments proceeded in the environment where 14 metallic ions coexist with gold ions, showed that the gold recovery rate was 99.9% or more when the concentration of gold ions and the concentration of 14 kinds of metallic ions were the same, and the gold recovery rate was approximately 99.5% when the concentration of 14 kinds of metallic ions was 10 times higher than the concentration of gold ions. In addition, the gold recovery rate was approximately 99.4% when the concentration of 14 metallic ions was 100 times higher than the concentration of gold ions.

### Experimental Example 5: Regeneration Characteristics of Gold Absorption Material with bPEI Introduced

The experiment proceeded on whether there is a change in the gold absorption performance when the gold absorption material used in the gold recovery process is regenerated and then applied to the gold recovery process again. Specifically, the gold ions absorption proceeded by adding the gold absorption material manufactured according to Experimental Example 3 at a concentration of 0.5 g/L to a solution of 10 ppm of gold ions, and then the gold absorption material was left for 24 hours in an aqueous solution in which 0.5 mol/L of thiourea and 0.1 M HCl were simultaneously included to regenerate the gold absorption material. This absorption and regeneration was repeated 10 times.

As illustrated in FIG. 9, the experimental result showed that the gold recovery rate was 99% or more after the absorption and regeneration were repeated 10 times, and the gold absorption rate was 100% until the fifth iteration, and then gradually decreased to about 91% at the tenth iteration.

### Experimental Example 6: Pressure Drop Characteristics of Gold Absorption Material with bPEI Introduced

The gold absorption material manufactured according to Experimental Example 3 was manufactured in powdered form (ALPP) and pelleted form (ALPFt), loaded into a column, and then the pressure drop was measured. The powdered form (ALPP) was made by grinding the gold absorption material manufactured according to Experimental Example 3 with a ball mill, and the pelleted form (ALPFt) was made in the form of a pellet by needle-punching the gold absorption material manufactured according to Experimental Example 3. The powdered (ALPP) and pelleted (ALPFt) forms were filled into a column of an inner diameter of 1.5 cm and a height of 15 cm with 5 g each, and the pressure drop was measured while ultrapure water was passed upward at a rate of 1 to 8 L/min.

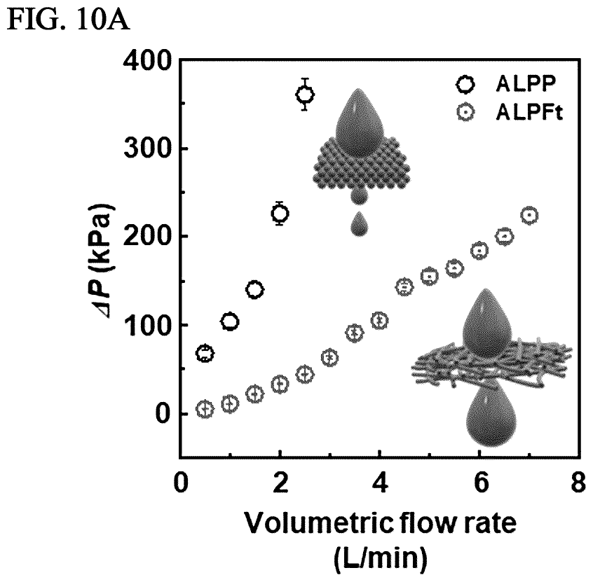

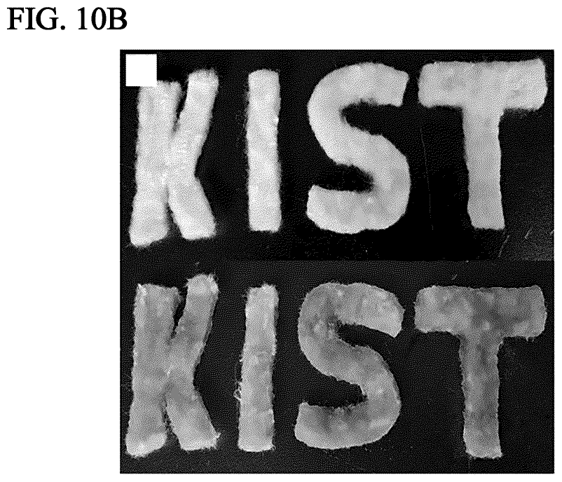

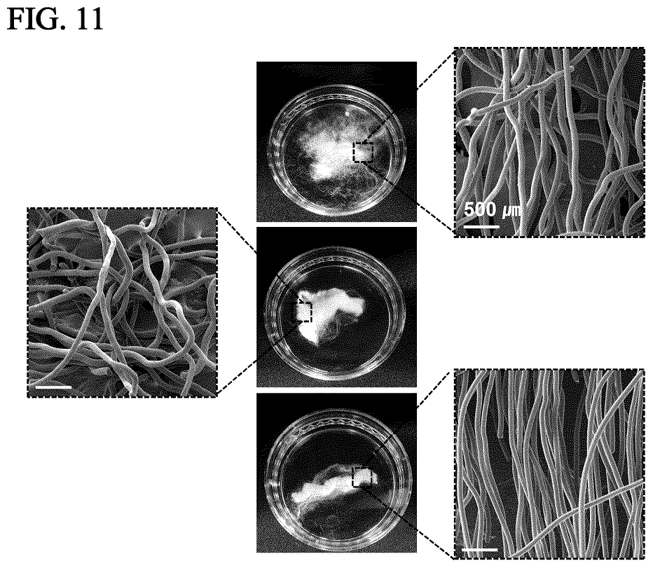

As illustrated in FIG. 10A, the experimental result showed that the AP increased exponentially when the powdered form (ALPP) was filled, whereas the AP was relatively very low when the pelleted form (ALPFt) was filled. With these results, it can be seen that the gold recovery process may be efficiently proceeded by weaving the gold absorption material according to the present invention into the pelleted form (ALPFt) and the like. For reference, FIG. 10B is a photograph illustrating that the gold absorption material according to the present invention is able to be woven into various shapes, and the gold absorption material is woven into the shape of a letter “KIST”.

TABLE 3

| | | | Adsorbent | Supplemental |
|---|---|---|---|---|
| Adsorbent | qₘ (mg/g) | pH | type | reference |
| Mesoporous MCM-41-NH₂ | 275 | 2.5 | Nanoscale | [1] |
| | | | powder | |
| UiO-66-TA | 372 | 2.0 | Nanoscale | [2] |
| | | | powder | |
| Metal-organic polymer | 1317 | 4.5 | Nanoscale | [3] |
| | | | powder | |
| MN-Si-BH | 257 | 5.0 | Nanoscale | [4] |
| | | | powder | |
| UiO-66-NH₂ | 650 | 2.5 | Nanoscale | [5] |
| | | | powder | |
| MoS₂ | 1133 | 2.5 | Nanoscale | [6] |
| | | | powder | |
| Hydrothermal carbon spherules | 147.5 | 4 | Nanoscale | [7] |
| | | | powder | |
| NH₂-ZIF-8 | 357 | 3 | Nanoscale | [8] |
| | | | powder | |
| N-2-(2-pyridyl)ethylchitosan | 965.1 | 0 | Nanoscale | [9] |
| | | | powder | |
| Fe₃O₄@SiO₂-SH | 84.75 | 5 | Nanoscale | [10] |
| | | | powder | |
| Resorcinol-formaldehyde-urea resin | 1600 | 2 | Nanoscale | [11] |
| | | | powder | |
| Mesoporous silica matrix immobilized | 642 | 2 | Nanoscale | [12] |
| bayberry tannin | | | powder | |
| DTDD-MOF | 1119 | 2 | Nanoscale | [13] |
| | | | powder | |
| PEI-PS-DVB | 787 | 8 | Nanoscale | [14] |
| | | | powder | |
| MNP-G3-EDTA | 3.6 | 6.5 | Nanoscale | [15] |
| | | | powder | |
| Amino-functionalized | 116.23 | 2 | Microscale | [16] |
| polystyrene | | | powder | |
| OMS-ME-SH | 231 | 2 | Microscale | [17] |
| | | | powder | |
| Modified magnetic chitosan | 478 | 7.0 | Microscale | [18] |
| | | | powder | |
| Thiol-ene hydrogels | 119 | 0.5 | Microscale | [19] |
| | | | powder | |
| Crosslinked poly-ethyleneimine resin | 943.5 | 2 | Microscale | [20] |
| | | | powder | |
| Crosslinked chitosan resin chemically | 70.34 | 2 | Microscale | [21] |
| modified with L-lysine | | | powder | |
| Polymer triazine-EDA | 548 | 2 | Microscale | [22] |
| Polymer triazine-TETA | 1003 | | powder | |
| Polymer triazine-PEHA | 1086 | | | |
| Polystyrene-supported 3-amino-1,2- | 220 | 4 | Microscale | [23] |
| propanediol | | | powder | |
| DACS-TA | 298.5 | 2 | Microscale | [24] |
| (bio-adsorbent) | | | powder | |
| Glutaraldehyde-crosslinked chitosan | 357.14 | 2 | Milliscale | [25] |
| beads | | | powder | |
| Acrylic copolymer bearing | 135 | 1 | Milliscale | [26] |
| dimethylaminobenzaldehyde | | | powder | |
| Graphene oxide impregnation in calcium | 81.87 | 2 | Milliscale | [27] |
| alginate matrix | | | powder | |
| Calcium alginate bead | 290 | 2 | Milliscale | [28] |
| | | | powder | |
| Imprinted porous alginate bead | 184.82 | <2.36 | Milliscale | [29] |
| | | | powder | |
| Zinc oxide template porous alginate | 388.01 | 1 | Milliscale | [30] |
| beads | | | powder | |
| Amine-rich polymeric capsule | 576 | 2 | Milliscale | [31] |
| | | | powder | |
| Modified thiol cotton fiber | 54-68 | 3 | Fiber | [32] |
| DAVF-PT | 535 | 3 | Fiber | [33] |
| DAVFs-CS | 322 | 2 | Fiber | [34] |
| PEI-modified chitosan fiber | 421.1 | 5.5 | Fiber | [35] |
| PANF-AT | 130.6 | 0 | Fiber | [36] |
| ALPF | 1463.0 | 1 | Fiber | This study |

[1] K. F. Lam, K. L. Yeung, G. Mckay, An investigation of gold absorption from a binary mixture with selective mesoporous silica adsorbents, J. Phys. Chem. B 110(5) (2006) 2187-2194.
[2] C. Wang, G. Lin, J. Zhao, S. Wang, L. Zhang, Y. Xi, X. Li, Y. Ying, Highly selective recovery of Au (III) from wastewater by thioctic acid modified Zr-MOF: Experiment and DFT calculation, Chem. Eng. J. 380 (2020) 122511
[3] W. Xu, X. Mo, S. Zhou, P. Zhang, B. Xiong, Y. Liu, Y. Huang, H. Li, K. Tang, Highly efficient and selective recovery of Au (III) by a new metal-organic polymer, J. Hazard. Mater. 380 (2019) 120844.
[4] H. Vojoudi, A. Badiei, A. Banaei, S. Bahar, S. Karimi, G. Mohammadi Ziarani, M. R. Ganjali, Extraction of gold, palladium and silver ions using organically modified silica-coated magnetic nanoparticles and silica gel as a sorbent, Microchim. Acta 184 (2017) 3859-3866.
[5] Z. Chang, F. Li, X. Qi, B. Jiang, J. Kou, C. Sun, Selective and efficient absorption of Au (III) in aqueous solution by Zr-based metal-organic frameworks (MOFs): An unconventional way for gold recycling, J. Hazard. Mater. 391 (2020) 122175.
[6] B. Feng, C. Yao, S. Chen, R. Luo, S. Liu, S. Tong, Highly efficient and selective recovery of Au (III) from a complex system by molybdenum disulfide nanoflakes, Chem. Eng. J. 350 (2018) 692-702.
[7] F. Wang, J. Zhao, M. Zhu, J. Yu, Y. S. Hu, H. Liu, Selective absorption-deposition of gold nanoparticles onto monodispersed hydrothermal carbon spherules: a reduction-deposition coupled mechanism, J. Mater. Chem. A 3(4) (2015) 1666-1674.
[8] S. Zhou, C. Hu, W. Xu, X. Mo, P. Zhang, Y. Liu, K. Tang, Fast recovery of Au (III) and Ag (I) via aminemodified zeolitic imidazolate framework-8, Appl. Organomet. Chem. 34(4) (2020) e5541.
[9] S. Bratskaya, Y. Privar, A. Ustinov, Y. Azarova, A. Pestov, Recovery of Au (III), Pt (IV), and Pd (II) using pyridylethyl-containing polymers: chitosan derivatives vs synthetic polymers, Ind. Eng. Chem. Res.55(39) (2016) 10377-10385.
[10] Y. Zhang, Q. Xu, S. Zhang, J. Liu, J. Zhou, H. Xu, H. Xiao, J. Li, Preparation of thiol-modified Fe3O4@SiO2 nanoparticles and their application for gold recovery from dilute solution, Sep. Purif. Technol. 116 (2013) 391-397.
[11] Y. Xiang, X. Chen, C. Cao, S. Ding, L. Xu, G. Liu, High performance and selectivity recovery of Au (III) from waste solution using the RFU resin, React. Funct. Polym. 154 (2020) 104637.
[12] X. Huang, Y. Wang, X. Liao, B. Shi, Adsorptive recovery of Au3+ from aqueous solutions using bayberry tannin-immobilized mesoporous silica, J. Hazard. Mater. 183(1-3) (2010) 793-798.
[13] Z. Huang, M. Zhao, C. Wang, S. Wang, L. Dai, L. Zhang, L. Xu, Selective removal mechanism of the novel Zr-based metal organic framework adsorbents for gold ions from aqueous solutions, Chem. Eng. J. 384 (2020) 123343.
[14] S. Qin, L. y. Ma, X. Sun, X. Mao, L. Xu, Hierarchically porous poly (ethylenimine) modified poly (styrene co-divinylbenzene) microspheres for the absorption of gold nanoparticles and simultaneously being transformed as the nanoparticles immobilized catalyst, J. Hazard. Mater. 366 (2019) 529-537.
[15] C. H. Yen, H. L. Lien, J. S. Chung, H. D. Yeh, absorption of precious metals in water by dendrimer modified magnetic nanoparticles, J. Hazard. Mater. 322 (2017) 215-222.
[16] Q. Xu, P. Yin, G. Zhao, Y. Sun, R. Qu, absorption selectivity and dynamic absorption behaviors of Cu (II), Ag (I), and Au (III) on silica gel encapsulated by amino functionalized polystyrene, J. Appl. Polym. Sci. 117(6) (2010) 3645-3650.
[17] S. Kim, S. Park, S. Han, Y. Han, J. Park, Silanol-rich ordered mesoporous silica modified thiol group for enhanced recovery performance of Au (III) in acidic leachate solution, Chem. Eng. J. 351 (2018) 1027-1037.
[18] M. Zhao, J. Zhao, Z. Huang, S. Wang, L. Zhang, One pot preparation of magnetic chitosan-cystamine composites for selective recovery of Au (III) from the aqueous solution, Int. J. Biol. Macromol. 137 (2019) 721-731.
[19] M. Firlak, E. K. Yetimoğlu, M. V. Kahraman, absorption of Au (III) ions from aqueous solutions by thiolene photoclick hydrogels and its application to electronic waste and geothermal water, J. Water Process. Eng. 3(2014) 105-116.
[20] F. Liu, L. Zhou, W. Wang, G. Yu, S. Deng, Adsorptive recovery of Au (III) from aqueous solution using crosslinked polyethyleneimine resins, Chemosphere 241 (2020) 125122.
[21] K. Fujiwara, A. Ramesh, T. Maki, H. Hasegawa, K. Ueda, absorption of platinum (IV), palladium (II) and gold (III) from aqueous solutions onto l-lysine modified crosslinked chitosan resin, J. Hazard. Mater. 146(1-2) (2007) 39-50.
[22] M. Can, M. Doğan, M. İmamoğlu, M. Arslan, Au (III) uptake by triazine polyamine polymers: Mechanism, kinetic and equilibrium studies, React. Funct. Polym. 109 (2016) 151-161.
[23] S. Changmei, Z. Guanghua, W. Chunhua, Q. Rongjun, Z. Ying, G. Quanyun, A resin with high absorption selectivity for Au (III): Preparation, characterization and absorption properties, Chem. Eng. J. 172(2-3) (2011) 713-720.
[24] F. Liu, G. Peng, T. Li, G. Yu, S. Deng, Au (III) absorption and reduction to gold particles on cost-effective tannin acid immobilized dialdehyde corn starch, Chem. Eng. J. 370 (2019) 228-236.[25] T. H. Bui, W. Lee, S. B. Jeon, K. W. Kim, Y. Lee, Enhanced Gold (III) absorption using glutaraldehydecrosslinked chitosan beads: Effect of crosslinking degree on absorption selectivity, capacity, and mechanism, Sep. Purif. Technol. 248 (2020) 116989.
[26] L. Tofan, I. Bunia, C. Paduraru, C. Teodosiu, Synthesis, characterization and experimental assessment of a novel functionalized macroporous acrylic copolymer for gold separation from wastewater, Process Saf. Environ. Prot. 106 (2017) 150-162.
[27] S. Saha, M. Venkatesh, H. Basu, M. V. Pimple, R. K. Singhal, Recovery of gold using graphene oxide/calcium alginate hydrogel beads from a scrap solid state detector, J. Environ. Chem. Eng. 7(3) (2019) 103134.
[28] E. Torres, Y. Mata, M. Blázquez, J. Munoz, F. González, A. Ballester, Gold and silver uptake and nanoprecipitation on calcium alginate beads, Langmuir 21(17) (2005) 7951-7958.
[29] X. Gao, J. Liu, M. Li, C. Guo, H. Long, Y. Zhang, L. Xin, Mechanistic study of selective absorption and reduction of Au (III) to gold nanoparticles by ion-imprinted porous alginate microspheres, Chem. Eng. J. 385 (2020) 123897.
[30] X. Gao, Y. Zhang, Y. Zhao, Zinc oxide templating of porous alginate beads for the recovery of gold ions, Carbohydr. Polym. 200 (2018) 297-304.
[31] Y. Jung, T. Do, U.S. Choi, K.-W. Jung, J.-W. Choi, Cage-like amine-rich polymeric capsule with internal 3D center-radial channels for efficient and selective gold recovery, Chem. Eng. J. 438 (2022) 135618.
[32] M. Yu, D. Sun, W. Tian, G. Wang, W. Shen, N. Xu, Systematic studies on absorption of trace elements Pt, Pd, Au, Se, Te, As, Hg, Sb on thiol cotton fiber, Anal. Chim. Acta 456(1) (2002) 147-155.
[33] F. Liu, S. Wang, S. Chen, absorption behavior of Au (III) and Pd (II) on persimmon tannin functionalized viscose fiber and the mechanism, Int. J. Biol. Macromol. 152 (2020) 1242-1251.
[34] F. Liu, S. Hua, L. Zhou, B. Hu, Development and characterization of chitosan functionalized dialdehyde viscose fiber for absorption of Au (III) and Pd (II), Int. J. Biol. Macromol. 173 (2021) 457-466.[35] S. I. Park, I. S. Kwak, M. A. Bae, J. Mao, S. W. Won, D. H. Han, Y. S. Chung, Y.-S. Yun, Recovery of gold as a type of porous fiber by using biosorption followed by incineration, Bioresour. Technol. 104 (2012) 208-214.
[36] W. Zhang, L. Wu, X. Han, L. Yao, S. Zhao, J. Sun, Y. Xu, J. Li, C. Xiong, Green chemical synthesis of new chelating fiber and its mechanism for recovery gold from aqueous solution, J. Hazard. Mater. 378 (2019) 120674.

What is claimed is:

1. A PAN fiber-based gold absorption material comprising a structure in which an alkylamine compound is immobilized on a PAN fiber surface to adsorb gold ions in water.

2. The PAN fiber-based gold absorption material of claim 1, wherein a maximum absorption capacity of gold is 600 mg/g or more.

3. The PAN fiber-based gold absorption material of claim 1, wherein the alkylamine compound has a molecular weight of 25,000 g/mol or more.

4. The PAN fiber-based gold absorption material of claim 1, wherein the alkylamine compound is immobilized by an amination reaction between the alkylamine compound and the PAN fiber, and
wherein a molarity of grafted molecules of the alkylamine compound is less than 1 mmol/g at an occasion when the amination reaction is terminated.

5. The PAN fiber-based gold absorption material of claim 1, wherein the alkylamine compound is a branched alkylamine compound.

6. The PAN fiber-based gold absorption material of claim 5, wherein the branched alkylamine compound is one of branched poly (ethyleneimine) (bPEI), iso-buthylamine, sec-buthylamine, iso-amylamine, phosphoethanolamine (PEA), trimethylamine, or iso-propylamine, or a combination thereof.

7. A method of recovering gold using a PAN fiber-based gold absorption material of claim 1, the method comprising:
acidifying a solution to be treated that includes gold ions; and
adding the PAN fiber-based gold absorption material to the solution to be treated under an acidic condition,
wherein, upon addition of the gold absorption material to the solution to be treated under the acidic condition, amine functional groups provided in an alkylamine compound are bonded with hydrogen ions (H+) to electrically form a (+) polar state, the gold ions are bonded with negative ions to form a (−) polar state, and other metallic ions present in the solution to be treated maintain a positive ionic state, the gold ions in the (−) polar state are adsorbed to the amine functional groups in the (+) polar state, and the other metallic ions maintaining the positive ionic state are not adsorbed to the amine functional groups in the (+) polar state.
